(19) United States
(12) Patent Application Publication
(10) Pub. No.: US 2022/0402543 A1
(43) Pub. Date: Dec. 22, 2022

(54) UNDER-HOOD STEERING GEAR SEAL INTEGRITY DIAGNOSTIC SYSTEM AND TEST METHOD TECHNICAL FIELD

(71) Applicant: Steering Solutions IP Holding Corporation, Saginaw, MI (US)

(72) Inventors: Kevin J. Haubenstricker, Frankenmuth, MI (US); Kevin M. McClendon, Frankenmuth, MI (US); Sainan Feng, Saginaw, MI (US); Robert D. Bazela, Lansing, MI (US)

(21) Appl. No.: 17/829,592

(22) Filed: Jun. 1, 2022

Related U.S. Application Data
(60) Provisional application No. 63/211,195, filed on Jun. 16, 2021.

(51) Int. Cl. B62D 5/04; B62D 5/30; B62D 5/22

(52) U.S. Cl. CPC B62D 5/0484; B62D 5/30; B62D 5/22

(57) ABSTRACT

A steering seal diagnostic system includes a steering linkage that is operatively connectable to a pair of road wheels. The steering seal diagnostic system also includes a sealed compartment containing at least a portion of the steering linkage. The steering seal diagnostic system further includes a pressure sensor positioned to detect an internal pressure within the sealed compartment over a range of travel of the steering linkage, wherein a pressure change lower than a pressure change threshold indicates a leak condition of the sealed compartment.

### CROSS-REFERENCE TO RELATED APPLICATION

This application claims the benefit of priority to U.S. Provisional Patent Application Ser. No. 63/211,195, filed Jun. 16, 2021, the disclosure of which is incorporated by referenced herein in its entirety.

### FIELD OF THE INVENTION

This disclosure relates to a steering systems and, more particularly, to an under-hood steering gear seal integrity diagnostic system and test method.

### BACKGROUND

A vehicle, such as a car, truck, sport utility vehicle, crossover, mini-van, marine craft, aircraft, all-terrain vehicle, recreational vehicle, or other suitable vehicles, include various steering system schemes, for example, steer-by-wire (SbW) and driver interface steering. Often, the various steering schemes include an electric power steering (EPS) system including components such as steering wheel, column, rack-pinion gear, electric motor actuator etc. The EPS helps the operator to steer a vehicle by providing necessary assist torque and feedback.

Under-hood EPS applications are required to be sealed from the under-hood environment to ensure the integrity of the mechanical and electrical components within the unit. Standard processes to ensure that the unit is sealed from water intrusion involves leak testing the EPS unit on a steering assembly line. Once proven to be sealed, testing in the field is not routinely performed.

This method of the leak testing on the steering assembly line is typically sufficient to ensure the gear integrity as it leaves the leak test stand on the steering assembly line, but does nothing to ensure steering gear sealing integrity as the gear travels down the assembly line, to the vehicle assembly plant, as it is installed in the vehicle, or again during the life of the vehicle.

Accordingly, it would be well received in the industry to be able to verify the integrity of the EPS gear seals when it is in the field in order to mitigate any risk of failure modes, such as the potential loss of assist events due to water intrusion, prior to their occurrence.

### SUMMARY

According to one aspect of the disclosure, a steering seal diagnostic system includes a steering linkage that is operatively connectable to a pair of road wheels. The steering seal diagnostic system also includes a sealed compartment containing at least a portion of the steering linkage. The steering seal diagnostic system further includes a pressure sensor positioned to detect an internal pressure within the sealed compartment over a range of travel of the steering linkage, wherein a pressure change lower than a pressure change threshold indicates a leak condition of the sealed compartment.

According to another aspect of the disclosure, a steering seal diagnostic system includes a steering linkage that is operatively connectable to a pair of road wheels. The steering seal diagnostic system also includes a sealed compartment containing at least a portion of the steering linkage. The steering seal diagnostic system further includes a pressure sensor positioned to detect an internal pressure within the sealed compartment over a range of travel of the steering linkage, wherein a pressure drop at a held steering position greater than a pressure threshold indicates a leak condition of the sealed compartment.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 schematically illustrates a steering system having a steering gear;

FIG. 2 is a perspective view of a steering rack assembly;

FIG. 3 is a plot of pressure vs. position for a steering gear operating under a properly sealed condition; and

FIG. 4 is a plot of pressure vs. position for the steering gear operating under an improperly sealed condition.

### DETAILED DESCRIPTION

The following discussion is directed to various embodiments of the disclosure. The embodiments disclosed herein should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present invention described herein may be incorporated into any suitable vehicle, such as a car, a truck, a sport utility vehicle, a mini-van, a crossover, any other passenger vehicle, any suitable commercial vehicle, or any other suitable vehicle. Moreover, principles of the present disclosure may apply to other vehicles, such as planes, boats, trains, drones, or other suitable vehicles. Moreover, the present invention may be incorporated into various steering system schemes and electric power steering (EPS) systems, including steer-by-wire systems.

As will be appreciated from the disclosure, a system and method is provided to limit the exposure to failures due to fluid intrusion, such as water intrusion. In particular, the system and test method provides the ability to verify a steering gear sealing condition throughout the life of the vehicle. Although sealing protection of a steering gear is discussed in detail herein, it is to be appreciated that other components of a steering system may be monitored for sealing conditions with the embodiments disclosed herein.

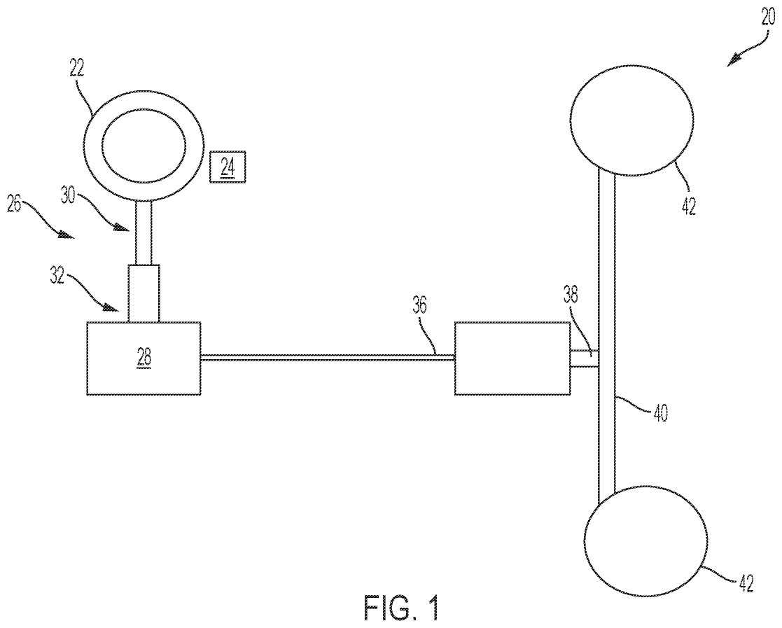

Referring initially to FIG. 1, a power steering system 20 is generally illustrated. The power steering system 20 may be configured as a driver interface steering system, an autonomous driving system, or a system that allows for both driver interface and autonomous or semi-autonomous steering. The steering system may include an input device 22, such as a steering wheel or other HWAs, wherein a driver may mechanically provide a steering input by turning the steering wheel. An airbag device 24 may be located on or near the input device 22. A steering column 26 extends along an axis from the input device 22 to an output assembly 28. The steering column 26 may include at least two axially adjustable parts, for example, a first portion 30 and a second portion 32 that are axially adjustable with respect to one another. The output assembly 28 may include a pinion shaft assembly, an I-shaft, a cardan joint, steer-by-wire components or any other features conventionally located opposite the input device 22. In other words, the steering column 26 may include a mechanical connection to the steering linkage (also referred to as a rack) or may be a steer-by-wire system that does not require a continuous mechanical connection. The output assembly 28 may connect to a power-assist assembly 34 via a connection 36. The connection 36 may be one of a steering gear input shaft, a continuation of the pinion shaft assembly, or wired or wireless digital communication protocols.

The power-assist assembly 34 may operably connect to a steering linkage 40 via a steering gear assembly. In operation, actuation of the driver input 22 causes a responsive movement of the power-assist assembly 34 and causes the steering linkage 40 to steer an associated vehicle. The power-assist assembly 34 may be part of a single pinion electronically assisted power steering (SPEPS) system, a dual pinion electronically assisted power steering (DPEPS) system, a column electrical power steering (CEPS) system, or a recirculation ball-type rack electrical power steering (REPS) system.

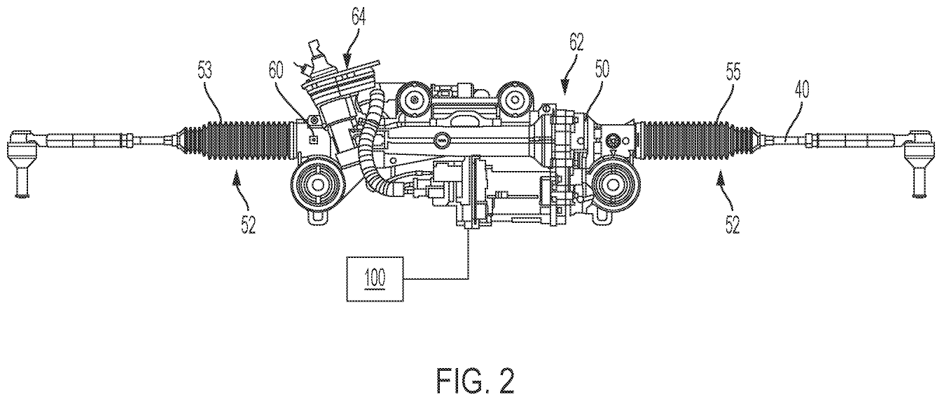

Referring now to FIG. 2, a portion of the steering column 26 passes under the hood of the vehicle, such that it is proximate the engine and fluid containing components. The disclosed system and testing method utilize a pressure sensor to sense the internal pressure of a sealed compartment that the steering linkage 40 is located within. In particular, a rack housing assembly 50 and a pair of seal boots 52 contain and seal the steering linkage 40 therein. More or fewer sealing components may be present in some embodiments, but the overall sealed compartment may be referred to herein as simply the sealed compartment. By way of non-limiting example, the steering system may include a single sealing boot 52 in some systems, such as in what may be referred to as a “single wheel actuator system.” In such a system, the monitored pressure change disclosed herein within the sealed compartment would fluctuate as the single boot is translated. It is to be understood that single boot embodiments are within the scope of the disclosed embodiments, as are overall sealed compartments with more sealing boots or other components.

The system and method disclosed herein monitor the internal pressure within the sealed compartment with a pressure sensor 60. It has been observed that a volume change occurring within the seal boots 52 during translation of the steering linkage 40 during steering events is imbalanced between an expanding and contracting boot. Therefore, as the steering linkage 40 is steered to the left or right, an internal pressure change within the sealed compartment occurs due to the changing volume of the two boots. This pressure change may vary depending on the particular application. This pressure change is not observable if a significant leak is present in either of the boots 52 or other sealing members which define the sealed compartment. Accordingly, the system and testing method disclosed herein monitors for a given level of pressure change during a steering cycle in order to verify that a significant leak is not present.

As disclosed above, the pressure sensor 60 is positioned to monitor the pressure within the sealed compartment to determine whether a leak is present in the sealed compartment. The pressure sensor 60 may be any type of sensor suitable for monitoring the pressure ranges found within the sealed compartment and for the overall packaging constraints. The pressure sensor 60 may be positioned in numerous contemplated locations associated with the sealed compartment. For example, the pressure sensor 60 may be located within a first sealing boot 53 of the sealing boots 52 or within a second sealing boot 55 of the sealing boots 52. By way of other non-limiting example, the pressure sensor 60 may be located within the rack housing assembly 50 proximate a gear assembly 62 powered by a motor or proximate a circuit card assembly 64. Alternative locations associated with the sealed compartment are also contemplated. Regardless of the precise location of the pressure sensor 60, the pressure sensor 60 is in operative communication (wired or wireless) with a processor and controller 100 that is able to convert the signal generated by the pressure sensor 60 into data that can be analyzed to assess whether the detected internal pressure of the sealed compartment is indicative of a leak.

The controller 100 compares the detected pressure change over a range of travel to a predetermined threshold pressure change. If a detected pressure change is lower than the threshold pressure change, the condition is indicative of a leak condition of the sealed compartment. In this event, the controller 100 issues a diagnostic warning if the leak condition is detected. The warning may be in the form of an alert to a vehicle operator or may be provided with special diagnostic tools used by maintenance personnel.

In another embodiment, the system and method analyze for a leak using the same inputs, but the steering maneuver (e.g., left turn or right turn) that results in the pressure change is held in that position to monitor pressure drop, which may allow for detection of a more refined leak rate. In such an embodiment, the pressure sensor 60 is in operative communication with the controller 100 and the controller 100 issues a diagnostic warning if the pressure drop exceeds a threshold pressure drop.

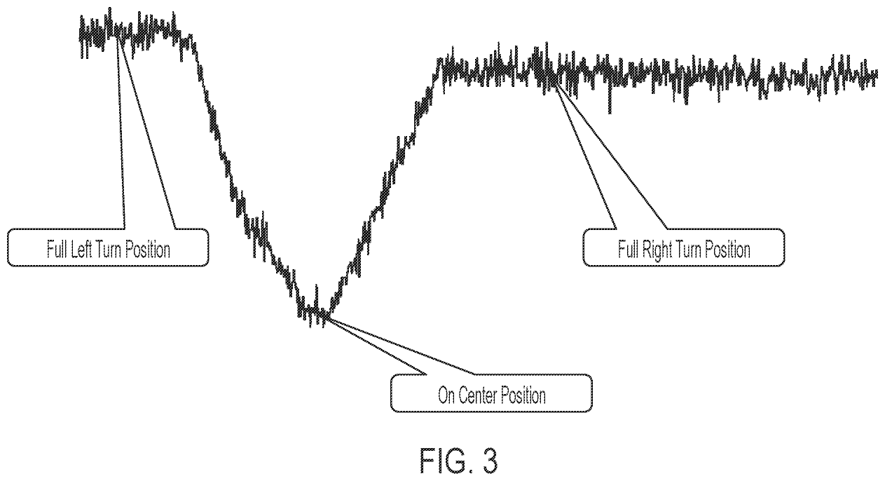

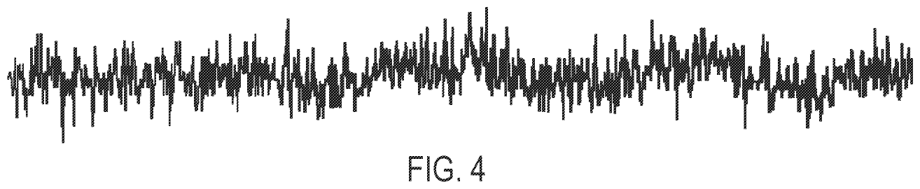

FIGS. 3 and 4 illustrate the above-described pressure changes exhibited under the unleaked and leaked conditions. In particular, FIG. 3 is a plot of pressure vs. steering position for a steering linkage operating under a properly sealed condition, while FIG. 4 is a plot of pressure vs. steering position for the steering linkage operating under an improperly sealed condition (e.g., plug has come loose or removed). As shown in FIG. 3, when the steering linkage is moved away from an “on center” position toward a right or left hand turn position, the pressure is noticeably different. In contrast, no significant pressure change is observed over a full steering travel range in FIG. 4, which is indicative of a leak.

The embodiments described herein may be used with a single pressure sensor in some embodiments. However, it is to be understood that more than one may be utilized for redundancy purposes. Nevertheless, the pressure sensor and monitoring during typical usage of the vehicle is less complex than prior leak diagnosing efforts that require several components and specific test routines.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description

What is claimed is:

1. A steering seal diagnostic system comprising:
a steering linkage that is operatively connectable to a pair of road wheels;
a sealed compartment containing at least a portion of the steering linkage; and
a pressure sensor positioned to detect an internal pressure within the sealed compartment over a range of travel of the steering linkage, wherein a pressure change lower than a pressure change threshold indicates a leak condition of the sealed compartment.

2. The steering seal diagnostic system of claim 1, wherein the sealed compartment comprises a rack housing assembly.

3. The steering seal diagnostic system of claim 2, wherein the sealed compartment further comprises a sealing boot disposed at an end of the rack housing assembly.

4. The steering seal diagnostic system of claim 1, wherein the sealed compartment comprises a rack housing assembly, a first sealing boot disposed at a first end of the rack housing assembly, and a second sealing boot disposed at a second end of the rack housing assembly.

5. The steering seal diagnostic system of claim 4, wherein the pressure sensor is at least partially disposed within the first boot.

6. The steering seal diagnostic system of claim 4, wherein the pressure sensor is at least partially disposed within the second boot.

7. The steering seal diagnostic system of claim 4, wherein the pressure sensor is at least partially disposed within the rack housing assembly.

8. The steering seal diagnostic system of claim 1, further comprising an additional pressure sensor positioned to detect an internal pressure within the sealed compartment over a range of travel of the steering linkage.

9. The steering seal diagnostic system of claim 8, wherein the pressure sensor and the additional pressure sensor are in operative communication with a controller.

10. The steering seal diagnostic system of claim 1, wherein the pressure sensor is in operative communication with a controller.

11. The steering seal diagnostic system of claim 10, wherein the controller issues a diagnostic warning if the leak condition is detected.

12. A steering seal diagnostic system comprising:
a steering linkage that is operatively connectable to a pair of road wheels;
a sealed compartment containing at least a portion of the steering linkage; and
a pressure sensor positioned to detect an internal pressure within the sealed compartment over a range of travel of the steering linkage, wherein a pressure drop at a held steering position greater than a pressure threshold indicates a leak condition of the sealed compartment.

13. The steering seal diagnostic system of claim 12, wherein the held steering position is a full left turn steering position.

14. The steering seal diagnostic system of claim 12, wherein the held steering position is a full right turn steering position.

15. The steering seal diagnostic system of claim 12, wherein the sealed compartment comprises a rack housing assembly, a first sealing boot disposed at a first end of the rack housing assembly, and a second sealing boot disposed at a second end of the rack housing assembly.

16. The steering seal diagnostic system of claim 12, wherein the sealed compartment comprises a rack housing assembly and a sealing boot disposed at an end of the rack housing assembly.

17. The steering seal diagnostic system of claim 15, wherein the pressure sensor is at least partially disposed within one of the first boot, the second boot, and the rack housing assembly.

18. The steering seal diagnostic system of claim 12, further comprising an additional pressure sensor positioned to detect an internal pressure within the sealed compartment over a range of travel of the steering linkage.

19. The steering seal diagnostic system of claim 12, wherein the pressure sensor is in operative communication with a controller.

20. The steering seal diagnostic system of claim 19, wherein the controller issues a diagnostic warning if the leak condition is detected.
